(19) United States
(12) Patent Application Publication
(10) Pub. No.: US 2009/0179841 A1
(43) Pub. Date: Jul. 16, 2009

(54) METHOD OF CONTROLLING LIQUID CRYSTAL DISPLAY DEVICE AND COMPUTER PROGRAM PRODUCT THEREFOR

(75) Inventor: Hugo Matthieu Visser, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/575,792

(22) PCT Filed: Sep. 22, 2005
(86) PCT No.: PCT/IB05/53123

§ 371 Date: Mar. 22, 2007

(30) Foreign Application Priority Data
Sep. 30, 2004 (EP) 04104779.6

(51) Int. Cl. G09G 3/36

(52) U.S. Cl. 345/88; 345/87

(57) ABSTRACT

A method of controlling a liquid crystal display monitor (2) is disclosed. The monitor has a liquid crystal display panel (4) having a plurality of pixels, a digital to analogue converter (30) for inputting image data to the display panel, and a backlight unit (20) having discharge lamps (22). A controller (26) determines whether an average brightness of an image is above a predetermined threshold value and sets the backlight unit (20) to a lower luminance setting in response to determination that said average brightness is above said threshold value to avoid discomfort to a user viewing the monitor.

The present invention relates to liquid crystal display devices, and relates particularly, but not exclusively to multi-purpose liquid crystal display devices for displaying medical and/or photographic images and having additional applications, such as email and document viewing/reading.

In particular, the invention relates to liquid crystal displays for mass consumer and professional such as medical applications having a high brightness mode (typically 500 nit) for image and TV viewing, and a low brightness mode for office applications such as email and document viewing. The brightness mode is automatically determined on basis of image analysis, as described in the following.

It is well known that medical images, in particular X-ray images, are best viewed at high brightness, enabling the user's eye to resolve more grey values of the image. This is particularly important, since in X-ray images, relevant features can have very low contrast. As a result, liquid crystal display (LCD) devices for viewing X-ray images are generally optimised to achieve high brightness, usually by omitting colour filters, but with the loss of colour.

High brightness colour LCD monitors have also been developed. These monitors have a more powerful and more efficient backlight than previous monitors, and have the advantage that because they also show colours, they can be used for a wider range of medical imaging applications because they can show the colours that are present in, for example, Doppler-ultrasound and segmented CT images. Such monitors can also be used for non-medical applications, for example office applications such as e-mail and document viewing/reading.

However, such monitors suffer from the drawback that the high illumination levels required to enable optimal viewing of X-ray images often causes discomfort to users when using the monitor for office applications such as e-mail and document viewing/reading.

US Patent Application US2002/0130830 discloses an LCD monitor having an adaptive luminance intensifying function for use when displaying moving TV and DVD images on the monitor. The display device determines whether images being displayed are still or video images, and when it is determined that the images are video images, the luminance of the backlight is controlled in response to levels of grey voltages within the image data. In particular, when the images are found to contain a large amount of high luminance levels, the luminance of the display backlight is increased, and when the image data is found to contain a large amount of low luminance levels, the luminance of normal level backlight is maintained, in order to implement high contrast of the image being displayed.

However, this arrangement is unsuitable for use in displaying medical images, since luminance control is only carried out in response to a determination that the images are moving images, and is not carried out for still images, and when it is determined that the images contain a large amount of high luminance data, the luminance level of the LCD backlight is increased. Such an arrangement would cause significant discomfort to a user when using a high luminance display for applications other than medical image viewing.

It is an object of the present invention to provide a method of controlling an LCD monitor to make the display less uncomfortable to users when using the monitor for applications other than medical or photographic image viewing.

According to an aspect of the present invention, there is provided a method of controlling a liquid crystal display monitor having a liquid crystal display panel including a plurality of pixels, at least one data input device for inputting image data to said liquid crystal display panel, and at least one illumination device for illuminating said liquid crystal display panel, wherein at least one said illumination device has at least one respective first mode and at least one respective second mode, wherein the luminance of said illumination device is higher in the or each said second mode than in the or each said first mode, the method comprising:
obtaining a plurality of first signals from respective sampled pixels, wherein said first signals represent luminance levels of respective sample pixels;
deriving at least one second signal from said first signals, wherein the or each said second signal represents an average brightness of said sampled pixels;
determining whether said average brightness is above a predetermined threshold value; and
setting at least one said illumination device to at least one first mode thereof in response to determination that said average brightness is above said threshold value.

By setting at least one said illumination device to at least one first mode thereof in response to determination that said average brightness is above said threshold value, this provides the advantage of automatically controlling the luminance setting of the display in response to the brightness content and automatically setting the illumination device to a lower illumination level for applications of higher brightness. For example, it is found that the average brightness of X-ray images and photographs is only about 10% of the peak white, whereas for other applications such as e-mail or document viewing, the image load is typically above 50%. By determining that the average brightness of an image is higher than a threshold level, this enables the luminance level to be automatically set to a lower intensity if the average brightness of the image to be displayed is likely to cause discomfort to a user.

The method preferably further comprises the step of determining whether image data represents still or moving images.

This provides the advantage of enabling the luminance to be automatically set to a lower level only in response to a determination that still images are being displayed.

By “still” images are meant images where the information content of the image, which is independent of the user, does not change over time, but also includes images where real time user dependent effects, such as a cursor displayed on the monitor, or colour or highlight information.

The step of determining whether the image data relates to still or moving images may comprise comparing data of consecutive image frames, and determining whether the amount of coincidence between said consecutive frames exceeds a predetermined level. The step of obtaining said first signals may comprise obtaining separate said first signals for different colour sub-pixels of at least some of said pixels.

The step of obtaining such second signal may comprise determining said average brightness from voltage input levels of said sampled pixels.

In one embodiment of the invention, at least one said illumination device has a plurality of said first modes of different luminances, and the step of setting said illumination device to at least one said first mode thereof in response to determination that said average brightness is above said threshold value comprises selecting said first mode in dependence upon said average brightness.

This provides the advantage of enabling the luminance level of the illumination device to be more closely matched to the average brightness of the image. For example, the luminance of at least one said illumination device may be controlled such that the higher the average brightness of an image being displayed, the lower the luminance level of the illumination device.

According to another aspect of the present invention, there is provided an illumination control data structure for use by a computer system for controlling a liquid crystal display monitor having a liquid crystal display panel including a plurality of pixels, at least one data input device for inputting image data to a plurality of said pixels, and at least one illumination device for illuminating the liquid crystal display panel and having at least one first mode and at least one second mode having higher luminance than the or each said first mode, the data structure including:
first computer code executable to receive a plurality of first signals from respective sampled pixels representing respective luminance levels of said sampled pixels;
second computer code executable to obtain from said first signals at least one second signal representing an average brightness of said sampled pixels;
third computer code executable to determine whether said average brightness is above a predetermined threshold value; and
fourth computer code executable to generate a control signal for use in setting at least one said illumination device to at least one first mode thereof in response to determination that said average brightness is above said threshold value.

The data structure may further comprise fifth computer code executable to determine whether image data input to the display device represents still or moving images.

The fifth computer code may be executable to compare consecutive images and determine whether the degree of coincidence between said consecutive images exceeds a predetermined level.

The data structure may further include sixth computer code executable to generate a control signal to set at least one said illumination device to at least one first mode thereof in response to determination that said image data relates to still images.

The fourth computer code may be executable to select one of a plurality of said first modes in dependence upon said average brightness.

According to a further aspect of the present invention, there is provided a computer readable medium carrying an illumination control data structure as defined above stored thereon.

According to a further aspect of the present invention, there is provided a liquid crystal display monitor comprising a liquid crystal display panel including a plurality of pixels, a data input device for inputting image data to said liquid crystal display panel, at least one illumination device for illuminating said liquid crystal display panel, and a control device having a data structure as defined above stored therein for controlling at least one said illumination device.

A preferred embodiment of the invention will now be described, by way of example only, and not in any limitative sense, with reference to the accompanying drawings, in which:

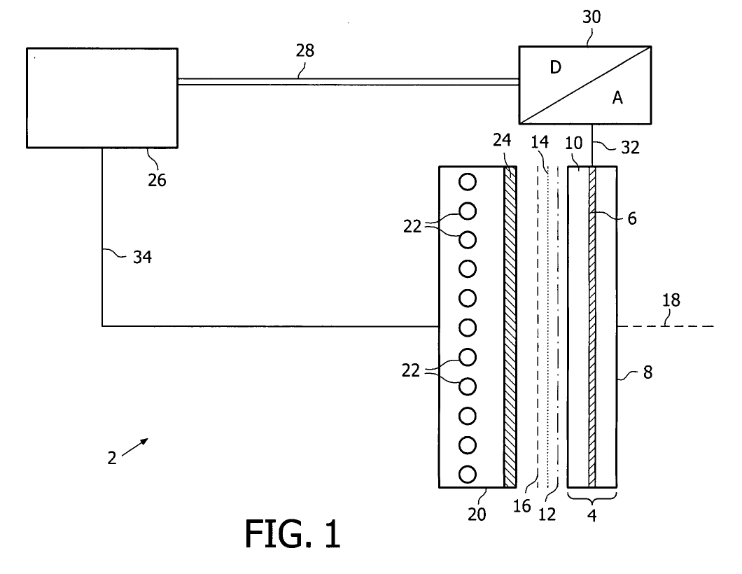

FIG. 1 is a schematic representation of a liquid crystal display monitor embodying the present invention;

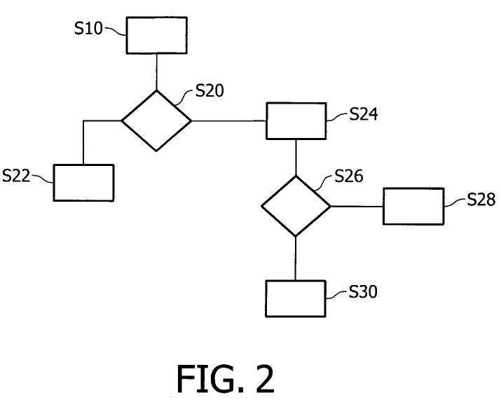

FIG. 2 is a flow diagram illustrating a method of controlling a backlight illuminator of the monitor of FIG. 1; and

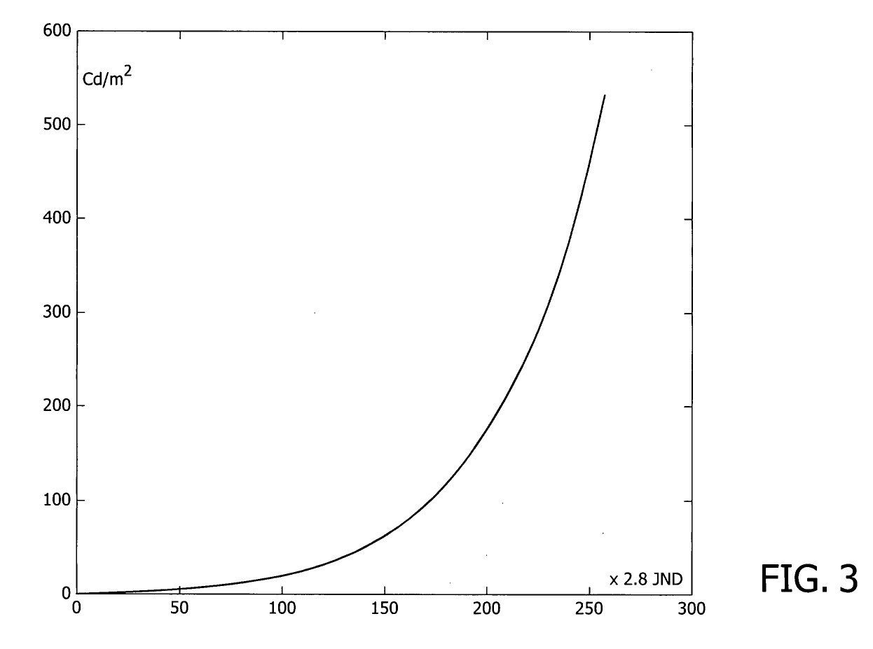

FIG. 3 is a graph showing variation of brightness of the monitor of FIG. 1 with input drive signal at full backlight power.

Referring to FIG. 1, a liquid crystal display (LCD) monitor 2 has a a backlit 1280×1024 pixel colour LCD panel 4. The LC material 6 is located between a first glass layer 8 and a second glass layer 10. The construction of colour LCD panels of this type is well known to persons skilled in the art and will therefore not be described in greater detail herein.

The pixels of the LCD panel 4 are generally square and are divided into sub-pixels by means of colour filters (not shown) which transmit only red, green and a blue light respectively. In order to enhance the brightness of the LCD monitor 2, the monitor 2 also includes a reflective polariser 12, a light diffusing foil 14 and a brightness enhancement foil 16, which collimates light towards normal viewing axis 18 of the monitor. The display panel 4 is illuminated by means of a light box 20 containing a row of fluorescent discharge tubes 22, and a diffuser 24 is located between the discharge tubes 22 and the display panel 4.

A controller 26 sends digital data signals, typically 8 bit signals, along data bus 28 to digital/analogue converter 30, which inputs analogue signals along a plurality of input lines 32 (of which only one is shown in FIG. 1 for purposes of clarity) to display panel 4. The analogue signals input along lines 32 determine the luminance of the individual sub-pixels to which they are directed. The controller 26 also sends control signals along line 34 to light box 20 to control the luminance of the fluorescent discharge tubes 22, in a manner, which will be described in greater detail below.

Referring now to FIG. 2, the operation of the controller 26 is described. At step S10, the current frame to be displayed by the display panel 4 is compared with the previous frame, and it is determined at step S20 whether the difference between the consecutive frames lies below a low threshold corresponding to minor differences between the frames, such as different cursor positions as a result of mouse movement by the user. If the differences are above the threshold, it is determined that the image data represents moving images, and the brightness of the backlight unit 20 remains unchanged at step S22. If, on the other hand, it is determined at step S20 that the differences between the consecutive frames are below the threshold, it is determined that the image data represents static images, and the image load is then determined at step S24.

Determination of the image load consists of determining an average brightness of all of the pixels of the display panel 4, or of a selected number of the pixels. The average brightness can be determined by determining the input voltage level of each sub pixel, from which the brightness of each corresponding sub pixel can be determined, for example from the transfer curve shown in FIG. 3, which shows variation of the brightness of a typical high brightness DICOM calibrated LCD having backlight at full power and an 8-bit input drive signal, as will be familiar to persons skilled in the art. If the image load, i.e. the average brightness of the image is determined at step S26 to be above a certain threshold, for example 40%, then it is determined that the image data to be displayed is not photographic or medical image date, but is likely to be an office application such as e-mail or document viewing/reading. As a result, a control signal is generated at step S28 which causes the controller 26 to lower the luminance setting of back lighter unit 20 to minimise discomfort to the user. If, on the other hand, the image load is not determined at step S26 to be above the threshold, it is assumed that the data represents photographic or medical image data, and the full brightness of the backlight unit 20 is set at step S30.

It will be appreciated by persons skilled in the art that the above embodiment has been described by way of example only, and not in any limitative sense, and that various alterations and modifications are possible without departure from the scope of the invention as defined by the appended claims. For example, instead of determining whether the image load is above a single threshold value, the controller 26 can determine whether the image load is above a plurality of threshold values, or a variable threshold value, and can select one of a plurality of low luminance settings of the backlight unit 20 in response to the image load determined. This enables the backlight luminance to be more closely matched to the average brightness of the image to be displayed.

1. A method of controlling a liquid crystal display monitor (2) having a liquid crystal display panel (4) including a plurality of pixels, at least one data input device (30) for inputting image data to said liquid crystal display panel, and at least one illumination device (22) for illuminating said liquid crystal display panel, wherein at least one said illumination device has at least one respective first mode and at least one respective second mode, wherein the luminance of said illumination device is higher in the or each said second mode than in the or each said first mode, the method comprising:
obtaining a plurality of first signals from respective sampled pixels, wherein said first signals represent luminance levels of respective sample pixels;
deriving at least one second signal from said first signals, wherein the or each said second signal represents an average brightness of said sampled pixels;
determining whether said average brightness is above a predetermined threshold value; and
setting at least one said illumination device to at least one first mode thereof in response to determination that said average brightness is above said threshold value.

2. A method according to claim 1, further comprising the step of determining whether image data represents still or moving images.

3. A method according to claim 2, wherein the step of determining whether the image data relates to still or moving images comprises comparing data of consecutive image frames, and determining whether the amount of coincidence between said consecutive frames exceeds a predetermined level.

4. A method according to claim 1, wherein the step of obtaining said first signals comprises obtaining separate said first signals for different colour sub-pixels of at least some of said pixels.

5. A method according to claim 1, wherein the step of obtaining said second signal comprises determining said average brightness from voltage input levels of said sampled pixels.

6. A method according to claim 1, wherein at least one said illumination device has a plurality of said first modes of different luminances, and the step of setting said illumination device to at least one said first mode thereof in response to determination that said average brightness is above said threshold value comprises selecting said first mode in dependence upon said average brightness.

7. An illumination control data structure for use by a computer system for controlling a liquid crystal display monitor having a liquid crystal display panel including a plurality of pixels, at least one data input device for inputting image data to a plurality of said pixels, and at least one illumination device for illuminating the liquid crystal display panel and having at least one first mode and at least one second mode having higher luminance than the or each said first mode, the data structure including:
first computer code executable to receive a plurality of first signals from respective sampled pixels representing respective luminance levels of said sampled pixels;
second computer code executable to obtain from said first signals at least one second signal representing an average brightness of said sampled pixels;
third computer code executable to determine whether said average brightness is above a predetermined threshold value; and
fourth computer code executable to generate a control signal for use in setting at least one said illumination device to at least one first mode thereof in response to determination that said average brightness is above said threshold value.

8. A data structure according to claim 7, further comprising fifth computer code executable to determine whether image data input to the display device represents still or moving images.

9. A data structure according to claim 8, wherein the fifth computer code is executable to compare consecutive images and determine whether the degree of coincidence between said consecutive images exceeds a predetermined level.

10. A data structure according to claim 7, further comprising sixth computer code executable to generate a control signal to set at least one said illumination device to at least one first mode thereof in response to determination that said image data relates to still images.

11. A data structure according to claim 7, wherein said fourth computer code is executable to select one of a plurality of said first modes in dependence upon said average brightness.

12. A computer readable medium carrying an illumination control data structure according to claim 7 stored thereon.

13. A liquid crystal display monitor (2) comprising a liquid crystal display panel (4) including a plurality of pixels, a data input device (30) for inputting image data to said liquid crystal display panel, at least one illumination device (22) for illuminating said liquid crystal display panel, and a control device (26) having a data structure according to claim 7 stored therein for controlling at least one said illumination device.
